(19) United States
(12) Patent Application Publication
(10) Pub. No.: US 2023/0302824 A1
(43) Pub. Date: Sep. 28, 2023

(54) PRINTING DEVICE INCLUDING PLATEN ROLLER CONFIGURED TO BE URGED TOWARD PRINT HEAD UPON ATTACHMENT OF CASSETTE

(71) Applicant: BROTHER KOGYO KABUSHIKI KAISHA, Nagoya (JP)

(72) Inventor: Yuya TAGAMI, Nagoya (JP)

(21) Appl. No.: 18/187,297

(22) Filed: Mar. 21, 2023

(30) Foreign Application Priority Data
Mar. 25, 2022 (JP) 2022-050443

(51) Int. Cl. B41J 11/14; B41J 2/32

(52) U.S. Cl. CPC B41J 11/14; B41J 2/32

(57) ABSTRACT

A printing device includes: a cassette accommodation portion; a print head; a platen roller; a platen holder; a platen gear; and a roller urging portion. The platen gear is configured to mesh with a transmission gear to receive a drive force therefrom. The platen gear is urged toward a rotational axis of the transmission gear. The platen roller includes: a platen shaft; a roller sleeve; and a roller body. The platen shaft extends through the roller sleeve in an axial direction thereof. The roller sleeve has an axial center portion connected to the platen shaft such that a torque can be transmitted from the platen shaft to the roller sleeve. The platen gear is fixed to the platen shaft and is positioned outside the roller sleeve in the axial direction. The roller urging portion is configured to urge the roller sleeve toward the print head.

### REFERENCE TO RELATED APPLICATIONS

This application claims priority from Japanese Patent Application No. 2022-050443 filed on Mar. 25, 2022. The entire content of the priority application is incorporated herein by reference.

### BACKGROUND ART

In a printing device configured to perform printing on a tape, a cassette accommodating a tape is mounted in and removed from a body of the printing device to supply and interchange the tape. In this type of printing device, a platen roller is urged against a print head to nip the tape between the platen roller and the print head.

In this this type of printing device, conventionally, an alignment mechanism for transmitting only torque is provided between a platen shaft and a sleeve of the platen roller in order to suppress misalignment of the platen roller.

In this configuration, the platen roller is driven by a platen gear coupled with the platen roller. The platen gear is in mesh with an output gear configured to transmit a drive force to the platen gear. The platen roller is applied with an urging force that is balanced by a nip load generated by the platen roller and a reaction force that the platen gear receives from the output gear.

### DESCRIPTION

In the conventional printing device described above, a conveyance torque varies depending on the type of the tape being used, since different types of tape produce different resistances when drawn off their rolls. Consequently, the reaction force received by the platen gear from the output gear also varies.

As a result, the nip load of the platen roller changes in order to balance the forces exerted on the platen roller. This means that the nip load varies according to the type of tape, which can be problematic.

In view of the foregoing, it is an object of the present disclosure to provide a printing device capable of stabilizing the nip load of the platen roller.

According to one aspect, the disclosure provides a printing device including: a cassette accommodation portion to which a printing cassette incorporating a printing tape is detachably attachable; a print head provided in the cassette accommodation portion; a platen roller configured to face the print head; a platen holder; a platen gear; and a roller urging portion configured to urge the platen roller toward the print head. The platen holder holds the platen roller such that the platen roller is rotatable about a platen-roller rotational axis. The platen holder is configured to move the platen roller in a direction crossing the platen-roller rotational axis. The platen gear is configured to mesh with a transmission gear to receive a drive force from the transmission gear. The platen gear is configured to be urged toward a transmission-gear rotational axis of the transmission gear. The platen roller includes: a platen shaft to which the platen gear is fixed; a roller sleeve extending in an axial direction; and a roller body provided over an outer peripheral surface of the roller sleeve. The platen shaft extends through the roller sleeve in the axial direction. The roller sleeve has a center portion and two outer end portions outside the center portion in the axial direction. The center portion is connected to the platen shaft such that a torque can be transmitted from the platen shaft to the roller sleeve. Each of the two outer end portions has an inner peripheral surface that is spaced away from an outer peripheral surface of the platen shaft. The platen gear is positioned outside the roller sleeve in the axial direction. The roller urging portion is configured to urge the roller sleeve toward the print head.

With this configuration, changes in the reaction force on the platen gear caused by changes in conveyance torque are suppressed by urging the platen gear toward the rotational axis of the transmission gear. As a result, the nip load of the platen roller can be stabilized while providing an alignment mechanism for the platen roller.

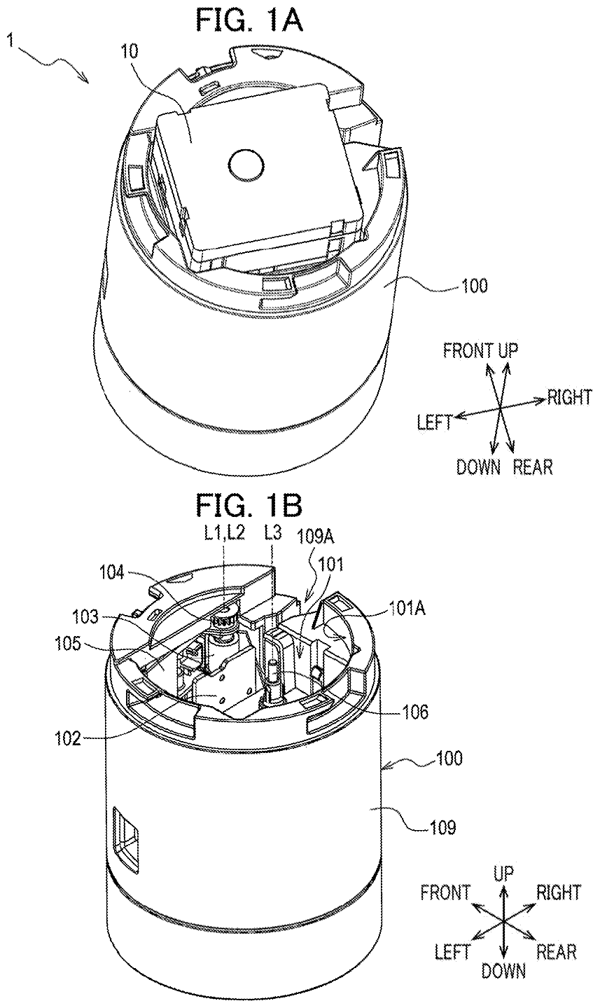

FIG. 1A is a schematic perspective view of a printing device according to one embodiment.

FIG. 1B is a schematic perspective view illustrating a device body of the printing device of FIG. 1A.

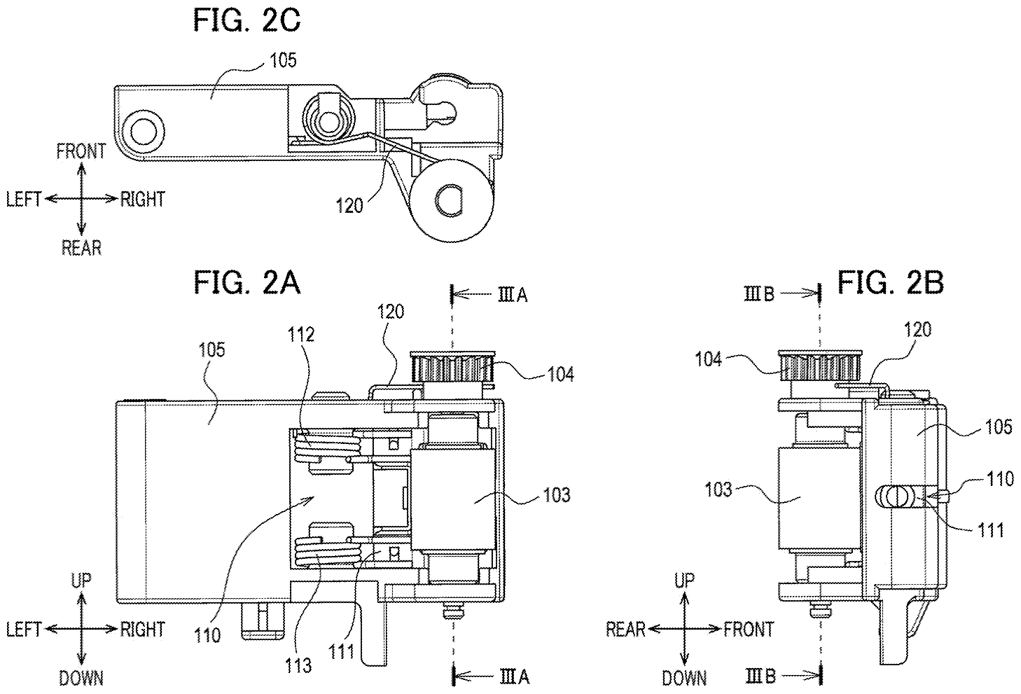

FIG. 2A is a schematic front view of a platen holder in the device body of FIG. 1B.

FIG. 2B is a schematic side view of the platen holder in FIG. 2A.

FIG. 2C is a schematic plan view of the platen holder in FIG. 2A.

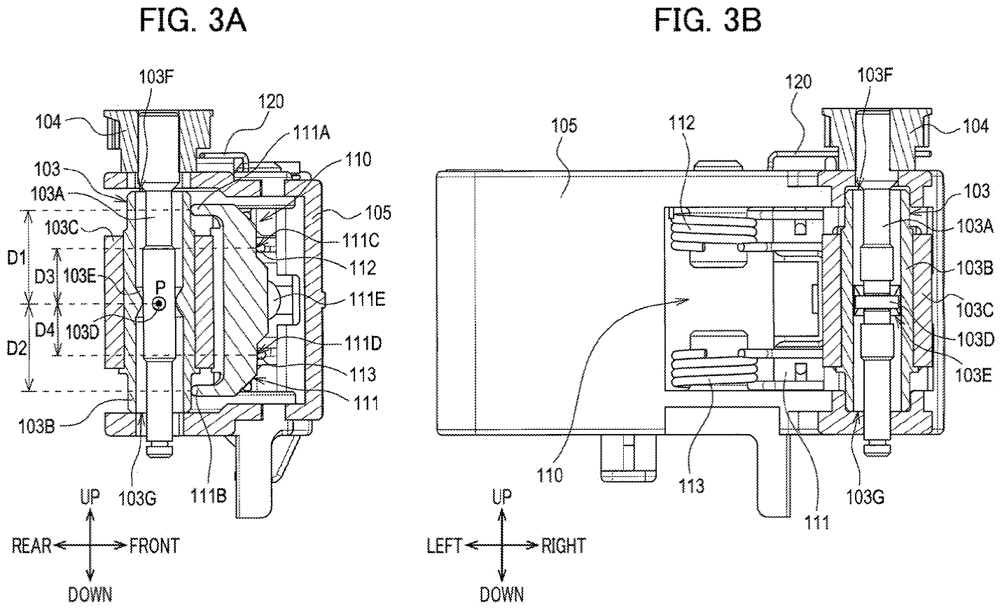

FIG. 3A is a schematic cross-sectional view of the platen holder taken along a line IIIA-IIIA in FIG. 2A.

FIG. 3B is a schematic cross-sectional view of the platen holder taken along a line IIIB-IIIB in FIG. 2B.

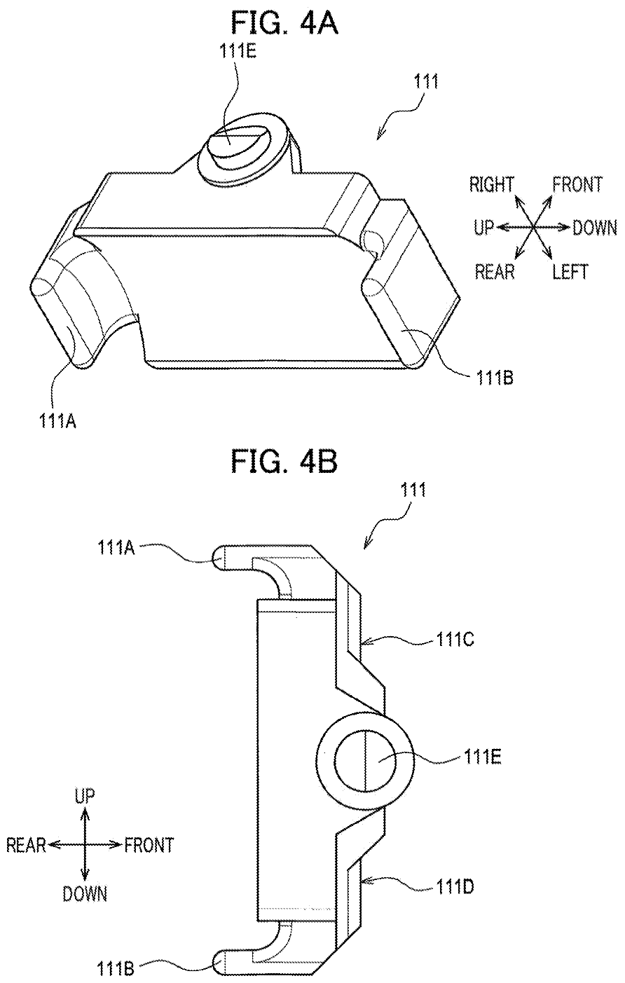

FIG. 4A is a schematic perspective view of a pressing member in the device body of FIG. 1B.

FIG. 4B is a schematic side view of the pressing member in FIG. 4A.

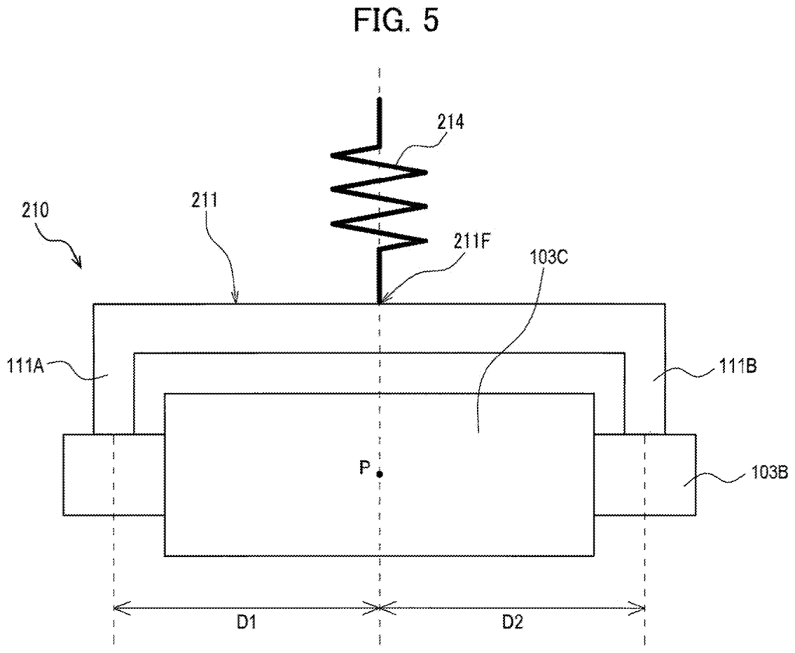

FIG. 5 is a schematic diagram illustrating a roller urging portion according to a modification to the embodiment.

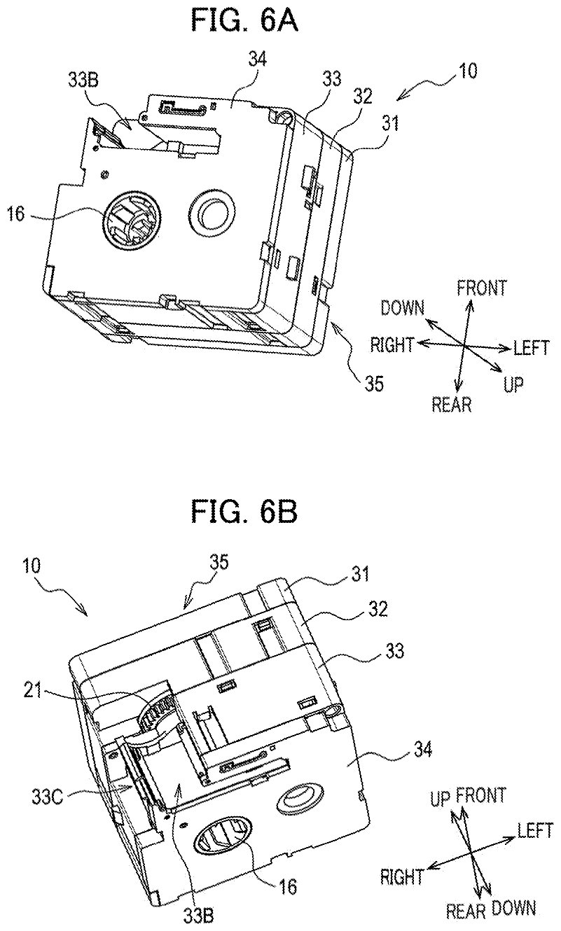

FIGS. 6A and 6B are schematic perspective views of a printing cassette for the printing device of FIG. 1A.

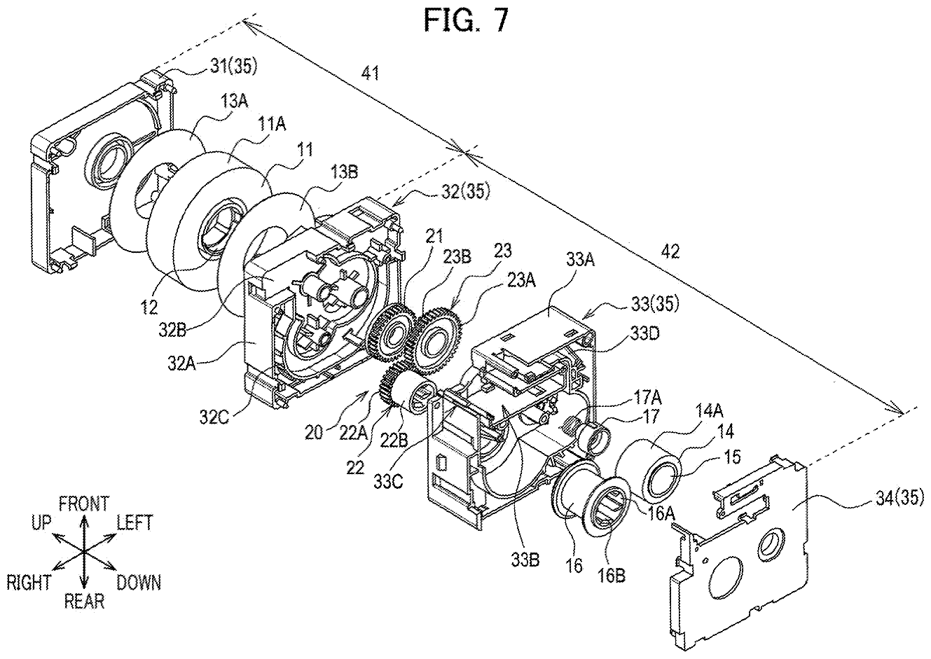

FIG. 7 is a schematic exploded perspective view of the printing cassette of FIG. 6A.

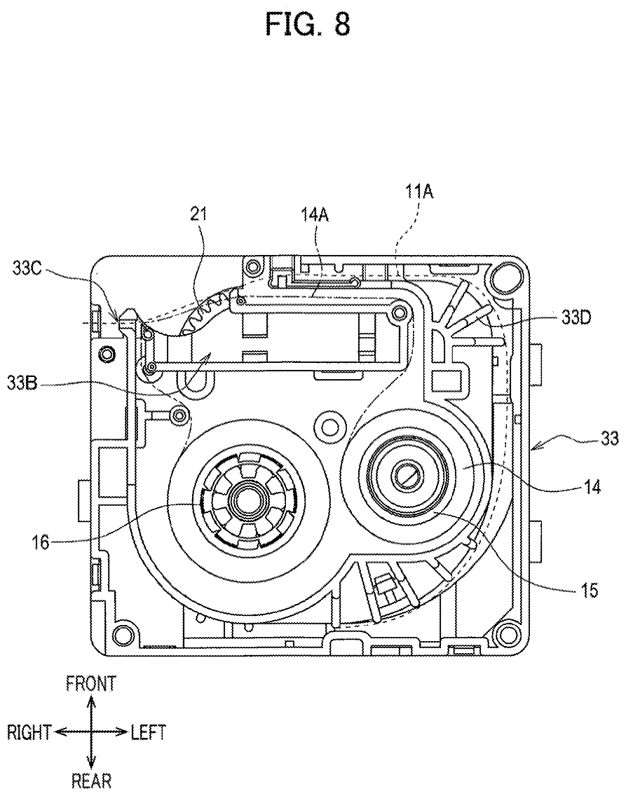

FIG. 8 is a schematic diagram illustrating paths for a printing tape and an ink ribbon in the printing cassette of FIG. 6A.

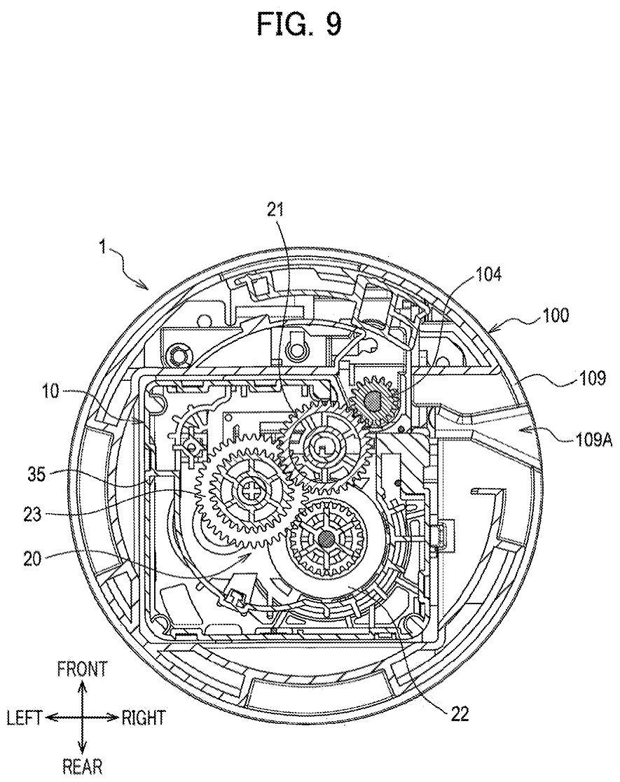

FIG. 9 is a schematic plan view illustrating a state of engagement between an output gear and a platen gear in the printing device of FIG. 1.

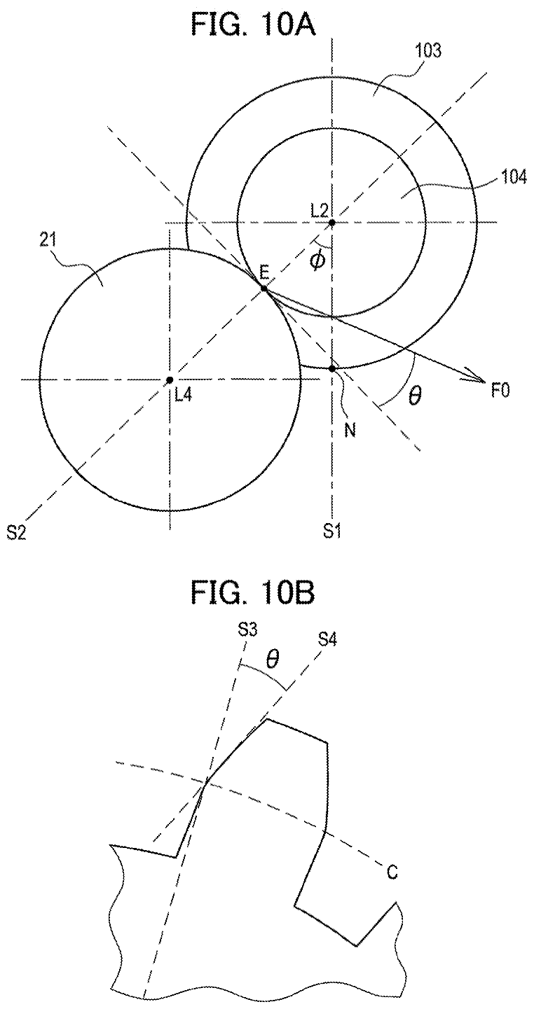

FIG. 10A is a diagram schematically illustrating the state of engagement between the output gear and the platen gear.

FIG. 10B is a schematic diagram for description of a pressure angle at the platen gear.

### EMBODIMENT

### 1. Configuration

A printing device 1 illustrated in FIG. 1 includes a printing cassette 10, and a device body 100. The printing device 1 is configured to perform printing on a printing tape 11A in the printing cassette 10 (see FIG. 7).

In the present embodiment, a direction parallel to a central axis of a printing tape roll 11 will be referred to as an up-down direction, a direction perpendicular to the up-down direction and parallel to a direction in which the printing tape 11A is discharged through an outlet 33C will be referred to as a left-right direction, and a direction perpendicular to both the up-down direction and the left-right direction will be referred to as a front-rear direction.

<Device Body 100>

As illustrated in FIG. 1B, the device body 100 includes a cassette accommodation portion 101, a print head 102, a platen roller 103, a platen gear 104, a platen holder 105, a drive shaft 106, and a housing 109.

As illustrated in FIGS. 2A, 2B, and 2C, the device body 100 further includes a roller urging portion 110, and a gear urging spring 120.

Cassette Accommodation Portion

The cassette accommodation portion 101 illustrated in FIG. 1B is a recess in which the printing cassette 10 is detachably mountable. The cassette accommodation portion 101 functions to provide positioning of the printing cassette 10.

The cassette accommodation portion 101 has an insertion opening 101A formed in the housing 109 to be open upward. The printing cassette 10 is inserted into the cassette accommodation portion 101 through the insertion opening 101A to be accommodated in the cassette accommodation portion 101. The housing 109 is formed with a slit-like discharge outlet 109A in communication with the cassette accommodation portion 101. The printing tape 11A in the printing cassette 10 accommodated in the cassette accommodation portion 101 is configured to be discharged out of the housing 109 through the discharge outlet 109A.

Print Head

The print head 102 is disposed inside the cassette accommodation portion 101. The print head 102 includes a plurality of heating elements which are configured to be heated individually by a controller (not shown).

Platen Roller and Platen Gear

The platen roller 103 is disposed inside the cassette accommodation portion 101 near the print head 102 so as to oppose the print head 102. The platen roller 103 is pivotably movable toward and away from the print head 102. The platen roller 103 defines a rotational axis L1 in parallel to the up-down direction.

The platen gear 104 is coupled with the platen roller 103. The platen gear 104 is engageable with an output gear 21 of the printing cassette 10, as will be described later. The platen gear 104 defines a rotational axis L2 which is coincident with the rotational axis L1 of the platen roller 103. The platen gear 104 is pivotable together with the platen roller 103. Into the platen roller 103, a drive force of the drive shaft 106 is configured to be inputted through the printing cassette 10 and the platen gear 104.

As illustrated in FIGS. 3A and 3B, the platen roller 103 includes a platen shaft 103A, a roller sleeve 103B, a roller body 103C, and a coupling pin 103D.

The platen shaft 103A is a shaft member to which the platen gear 104 is fixed. The platen shaft 103A is rotatable, relative to the platen holder 105, about the rotational axis L1 together with the platen gear 104.

The roller sleeve 103B is a cylindrical member through which the platen shaft 103A penetrates. The roller sleeve 103B has a center portion in an axial direction thereof where a reduced diameter portion 103E is formed. The roller sleeve 103B has an inner diameter greater than an outer diameter of the platen shaft 103A, except in the reduced diameter portion 103E.

The roller body 103C is a cylindrical member mounted over an outer peripheral surface of the roller sleeve 103B. The roller body 103C is rotatable together with the roller sleeve 103B. The roller body 103C is configured to nip the printing tape 11A in cooperation with the print head 102.

The coupling pin 103D is a rod-like member that couples the platen shaft 103A and the roller sleeve 103B together. The coupling pin 103D penetrates through the platen shaft 103A in a direction orthogonal to the axial direction (i.e., a radial direction of the platen shaft 103A).

The coupling pin 103D has both ends connected to the reduced diameter portion 103E of the roller sleeve 103B. Accordingly, the axial center portion of the roller sleeve 103B (reduced diameter portion 103E) is coupled to the platen shaft 103A by the coupling pin 103D such that torque can be transmitted from the platen shaft 103A to the roller sleeve 103B. The roller sleeve 103B is configured to be rotated by the coupling pin 103D which rotates together with the platen shaft 103A.

The roller sleeve 103B is not in contact with the platen shaft 103A in areas other than the reduced diameter portion 103E. That is, a gap is formed between an inner peripheral surface of the roller sleeve 103B and an outer peripheral surface of the platen shaft 103A in two end areas 103F and 103G of the roller sleeve 103B which are outside the reduced diameter portion 103E in the axial direction (i.e., upper end lower end portions of the roller sleeve 103B in the axial direction).

The platen shaft 103A is pivotable relative to the roller sleeve 103B about the coupling pin 103D. Hence, a reaction force of the platen gear 104 coupled to the platen shaft 103A is not transmitted to the roller sleeve 103B. That is, the coupling pin 103D and the reduced diameter portion 103E of the roller sleeve 103B constitute an alignment mechanism of the platen roller 103.

The platen gear 104 is arranged outside the roller sleeve 103B in the axial direction of the platen shaft 103A. Specifically, the platen gear 104 is provided above the roller sleeve 103B. The platen gear 104 is configured to meshingly engage with the output gear 21 of the mounted printing cassette 10 which is configured to receive the driving force from the drive shaft 106. The platen gear 104 is also urged toward a rotational axis L4 of the output gear 21 (see FIG. 10) by the gear urging spring 120.

Platen Holder

The platen holder 105 holds the platen roller 103 and the platen gear 104. The platen holder 105 is configured to move the platen roller 103 in a direction crossing the rotational axis L1 of the platen roller 103. The platen holder 105 is mounted in the housing 109 such that the platen holder 105 is pivotable in the front-rear direction relative to the housing 109.

Roller Urging Portion

The roller urging portion 110 is configured to urge the platen roller 103 toward the print head 102. Specifically, the roller urging portion 110 is configured to apply pressure to the roller sleeve 103B. The roller urging portion 110 includes a pressing member 111, a first roller urging spring 112, and a second roller urging spring 113.

The pressing member 111 is in contact with the roller sleeve 103B. The pressing member 111 is arranged opposite the print head 102 with respect to the roller sleeve 103B (i.e., on the front of the roller sleeve 103B).

As illustrated in FIGS. 4A and 4B, the pressing member 111 has a first operating part 111A, a second operating part 111B, a first pressure receiving part 111C, a second pressure receiving part 111D, and a coupling part 111E.

The first operating part 111A and the second operating part 111B are protruding parts respectively in contact with the roller sleeve 103B. The first operating part 111A and the second operating part 111B are arranged apart from each other in the axial direction of the roller sleeve 103B (i.e., the up-down direction). The first operating part 111A is positioned above the second operating part 111B.

The first pressure receiving part 111C is a portion that contacts the first roller urging spring 112, and the second pressure receiving part 111D is a portion that contacts the second roller urging spring 113. The first pressure receiving part 111C and the second pressure receiving part 111D are separated from each other in the axial direction of the roller sleeve 103B (i.e., the up-down direction). The first pressure receiving part 111C is positioned above the second pressure receiving part 111D.

The coupling part 111E is rotatably connected to the platen holder 105. That is, the pressing member 111 is mounted on the platen holder 105 through the coupling part 111E such that the pressing member 111 is pivotable relative to the platen holder 105.

The first roller urging spring 112 and the second roller urging spring 113 illustrated in FIGS. 3A and 3B respectively apply urging forces thereof to the pressing member 111 to press the pressing member 111 against the roller sleeve 103B.

The first roller urging spring 112 and the second roller urging spring 113 are coil springs held by the platen holder 105. Specifically, the first roller urging spring 112 and the second roller urging spring 113 are arranged between the platen holder 105 and the pressing member 111.

The first roller urging spring 112 urges the first pressure receiving part 111C of the pressing member 111 rearward. The second roller urging spring 113 urges the second pressure receiving part 111D of the pressing member 111 rearward.

As illustrated in FIG. 3A, the first pressure receiving part 111C and the second pressure receiving part 111D are positioned between the first operating part 111A and the second operating part 111B in the axial direction of the roller sleeve 103B. In other words, the first operating part 111A is positioned above the first pressure receiving part 111C, and the second operating part 111B is positioned below the second pressure receiving part 111D.

Further, in the axial direction of the roller sleeve 103B, a distance D1 from a center P of the roller sleeve 103B to the first operating part 111A is equal to a distance D2 from the center P of the roller sleeve 103B to the second operating part 111B. Similarly, in the axial direction of the roller sleeve 103B, a distance D3 from the center P of the roller sleeve 103B to the first pressure receiving part 111C is equal to a distance D4 from the center P of the roller sleeve 103B to the second pressure receiving part 111D.

Here, conditions at which moments at the first operating part 111A are balanced (i.e., no moment is generated) can be represented by a following equation (1),

F3×(D1−D3)+F4×(D1+D4)=F2×(D1+D2) equation (1),

in which:

F1 represents a load applied to the roller sleeve 103B from the first operating part 111A;

F2 represents a load applied to the roller sleeve 103B from the second operating part 111B;

F3 represents a load applied to the first pressure receiving part 111C from the first roller urging spring 112; and

F4 represents a load applied to the second pressure receiving part 111D from the second roller urging spring 113.

Similarly, conditions at which moments at the first operating part second operating part 111B are balanced can be represented by a following equation (2).

F4×(D2−D4)+F3×(D2+D3)=F1×(D1+D2) equation (2)

Based on the above equations (1) and (2) and the relationships D1=D2 and D3=D4, a following equation (3) can be obtained.

F1−F2=(D3/D1)×(F3−F4) equation (3)

The equation (3) indicates that, the smaller a value D3/D1 is, the smaller the difference between the load F1 of the first operating part 111A and the load F2 of the second operating part 111B resulting from a variation between the load F3 of the first pressure receiving part 111C and the load F4 of the second pressure receiving part 111D will be.

In the present embodiment, the value D3/D1 is smaller than 1 (D3/D1<1). Accordingly, the difference between the load F1 of the first operating part 111A and the load F2 of the second operating part 111B can be smaller (reduced), thereby suppressing variation in pressing forces in the axial direction of the roller body 103C.

FIG. 5 illustrates a variation of the roller urging portion 110 according to the embodiment. In the example of FIG. 5, a roller urging portion 210 according to this variation includes a pressing member 211, and a single roller urging spring 214. The pressing member 211 has a single pressure receiving part 211F, instead of the first and second pressure receiving parts 111C, 111D of the embodiment. That is, the pressing member 211 includes the pressure receiving part 211F, in addition to the first operating part 111A and the second operating part 111B of the embodiment. The pressure receiving part 211F is arranged at a position overlapping the axial center P of the roller sleeve 103B in a radial direction of the roller sleeve 103B. The pressure receiving part 211F is in contact with the single roller urging spring 214.

In the axial direction of the roller sleeve 103B, the distance D1 from the pressure receiving part 211F to the first operating part 111A is equal to the distance D2 from the pressure receiving part 211F to the second operating part 111B. In the variation of FIG. 5, the pressing member 211 is urged by the single roller urging spring 214. Accordingly, unlike the pressing member 111 of the embodiment, there is no need to consider balancing between the load F3 and load F4 in the equation (3) described above.

Gear Urging Spring

The gear urging spring 120 illustrated in FIG. 2A urges the platen shaft 103A toward the output gear 21 of the printing cassette 10 (i.e., rearward) to urge the platen gear 104 toward the rotational axis L4 of the output gear 21.

The gear urging spring 120 is a coil spring held by the platen holder 105. That is, the gear urging spring 120 is disposed between the platen holder 105 and the platen shaft 103A.

Drive Shaft

The drive shaft 106 illustrated in FIG. 1B is to be inserted into a take-up spool 16 and an input gear 22 (see FIGS. 6, 7) of the printing cassette 10. The drive shaft 106 is configured to input a drive force into the printing cassette 10 for rotating the take-up spool 16 and the input gear 22.

The drive shaft 106 is disposed inside the cassette accommodation portion 101. The drive shaft 106 defines a rotational axis L3 aligned in the up-down direction. The drive shaft 106 is rotatable about the rotational axis L3 by a drive source (not illustrated).

<Printing Cassette>

The printing cassette 10 houses the printing tape 11A therein. The printing cassette 10 is attachable to and detachable from the device body 100. By replacing the printing cassette 10 with a new one, the printing tape 11A can be replenished and/or the type of the printing tape 11A (such as the size, color, material, and the like) can be changed.

As illustrated in FIGS. 6A and 6B, the printing cassette 10 includes a case 35 that houses at least a portion of the printing tape 11A and at least a portion of an ink ribbon 14A (as an auxiliary tape).

The printing cassette 10 (i.e., the case 35) has a rectangular parallelepiped shape with parallel sides aligned in the up-down direction, parallel sides aligned in the front-rear direction, and parallel sides aligned in the left-right direction. The case 35 (printing cassette 10) can be inserted downward into the cassette accommodation portion 101.

As illustrated in FIG. 7, the printing cassette 10 includes a printing tape roll 11, a first supply spool 12, an auxiliary tape roll 14, a second supply spool 15, the take-up spool 16, a clutch spring holder 17, and a drive transmission mechanism 20.

Printing Tape Roll

The printing tape roll 11 is configured of the strip-like printing tape 11A wound around the first supply spool 12. The printing tape 11A is subjected to printing. Specifically, printing is performed on a front surface of the printing tape 11A by the print head 102 of the device body 100 using the ink ribbon 14A.

Two spacer films 13A and 13B are disposed on respective outer sides of the printing tape roll 11 in the up-down direction to sandwich the printing tape roll 11 therebetween. The spacer film 13A is interposed between the printing tape roll 11 and a first cover part 31 (described later) of the case 35. The spacer film 13B is interposed between the printing tape roll 11 and a first frame part 32 (described later) of the case 35.

First Supply Spool

The first supply spool 12 is rotatable about a rotational axis aligned in the up-down direction. The first supply spool 12 is rotatable following conveyance of the printing tape 11A by the platen roller 103 of the device body 100, thereby supplying the printing tape printing tape 11A to the print head 102. The rotational axis of the first supply spool 12 is coincident with a winding axis (rotational axis) of the printing tape roll 11.

Auxiliary Tape Roll

The auxiliary tape roll 14 is configured of the strip-like ink ribbon 14A wound around the second supply spool 15. The ink ribbon 14A is used for printing the printing tape 11A.

The ink ribbon 14A is configured to be overlaid on the printing tape 11A within a head opening 33B (described later) where printing is performed on the printing tape 11A through the ink ribbon 14A by the print head 102. After being used for printing, the ink ribbon 14A is configured to be taken up over the take-up spool 16.

With respect to the up-down direction, the auxiliary tape roll 14 is at a position different from the printing tape roll 11. Specifically, the auxiliary tape roll 14 is positioned below the printing tape roll 11. Further, at least a portion of the auxiliary tape roll 14 is arranged to overlap with (aligned with) the printing tape roll 11 in the up-down direction.

Second Supply Spool

The second supply spool 15 is rotatable about a rotational axis thereof aligned in the up-down direction.

The second supply spool 15 is rotatable flowing movement of the ink ribbon 14A taken up by the take-up spool 16, thereby supplying the ink ribbon 14A to the print head 102. The second supply spool 15 is applied with rotational resistance by a clutch spring 17A held in the clutch spring holder 17.

Take-Up Spool

The take-up spool 16 is rotatable about a rotational axis parallel to the rotational axis of the second supply spool 15.

The take-up spool 16 is cylindrical, and has an inner circumferential surface 16A defining a hollow space in the cylindrical take-up spool 16. Splines 16B are formed on the inner circumferential surface 16A of the take-up spool 16. The drive shaft 106 of the device body 100 is configured to be engaged with the splines 16B. The take-up spool 16 is configured to be rotated by the drive shaft 106 to take up the ink ribbon 14A that was used for printing.

Drive Transmission Mechanism

The drive transmission mechanism 20 is configured to transmit the drive force received from the drive shaft 106 to the platen roller 103 when the printing cassette 10 has been attached to the device body 100. The drive transmission mechanism 20 includes the output gear 21, the input gear 22, and an idle gear 23.

The printing tape roll 11, the drive transmission mechanism 20, and the take-up spool 16 are arranged in order mentioned from top with respect to the up-down direction.

Output Gear

The output gear 21 is an external gear for externally outputting the drive force to be used for conveying the printing tape 11A. Specifically, the output gear 21 is configured to transmit the drive force to the platen gear 104 of the device body 100.

The output gear 21 is rotatable about the rotational axis L4 (see FIG. 10A) which is parallel to the rotational axis of the second supply spool 15. A part of the output gear 21 is exposed to a space in communication with the head opening 33B (see FIG. 6B). The output gear 21 can engage the platen gear 104 in the space communicating with the head opening 33B in a state where the printing cassette 10 is mounted in the device body 100 (i.e., in a state where the case 35 is accommodated in the cassette accommodation portion 101).

Input Gear

The input gear 22 is indirectly engaged with the output gear 21 via the idle gear 23. The input gear 22 is thus configured to transmit the drive force to the output gear 21.

The input gear 22 has an external gear 22A, and a spool 22B. The spool 22B is a cylindrical internal gear, and has an inner circumferential surface formed with splines. The spool 22B is fixed to one side surface of the external gear 22A. The external gear 22A is thus rotatable together with the spool 22B by the drive force inputted into the spool 22B. The input gear 22 defines a rotational axis (which is coincident with rotational axes of the external gear 22A and the spool 22B) which is aligned with (i.e., positioned on an extension line of) the rotational axis of the take-up spool 16.

The rotational axis of the input gear 22 is aligned with the hollow space of the take-up spool 16 in the up-down direction. Accordingly, the drive shaft 106 can be inserted simultaneously into the take-up spool 16 and the input gear 22 when the printing cassette 10 is mounted in the device body 100. As a result, the input gear 22 is cause to rotate together with the take-up spool 16 by the drive shaft 106, although the input gear 22 is not directly coupled to the take-up spool 16.

Idle Gear

The idle gear 23 is drivingly connected to (meshes with) the input gear 22 and the output gear 21 for transmitting the drive force inputted into the input gear 22 to the output gear 21.

The idle gear 23 is a stepped gear configured of an upstream gear 23A and a downstream gear 23B coaxially arranged with each other. The upstream gear 23A meshes with the input gear 22, and the downstream gear 23B meshes with the output gear 21. The downstream gear 23B has a diameter smaller than a diameter of the upstream gear 23A. Further, the downstream gear 23B is positioned closer to the printing tape roll 11 than the upstream gear 23A is to the printing tape roll 11 in the up-down direction. That is, the downstream gear 23B is positioned above the upstream gear 23A.

The idle gear 23 is configured to transmit the drive force inputted into the input gear 22 to the output gear 21 while reducing the rotational speed of the drive force. That is, the drive transmission mechanism 20 includes a reduction mechanism according to which a transmission ratio obtained by dividing the rotational speed of the input gear 22 by the rotational speed of the output gear 21 can be set as a reduction ratio.

Case

The case 35 includes the first cover part 31, the first frame part 32, a second frame part 33, and a second cover part 34.

The first cover part 31 constitutes a top portion of the printing cassette 10. The first frame part 32 is provided below the first cover part 31 and is coupled to the first cover part 31 in the up-down direction. The second frame part 33 is provided below the first frame part 32 and is coupled to the first frame part 32 in the up-down direction. The second cover part 34 constitutes a bottom portion of the printing cassette 10. The second cover part 34 is coupled to the second frame part 33 in the up-down direction.

The first cover part 31 and the first frame part 32 constitute a first case compartment 41 that accommodates the printing tape roll 11 therein. In other words, the printing tape roll 11 is accommodated in a space enclosed by the first cover part 31 and the first frame part 32.

The first frame part 32, the second frame part 33, and the second cover part 34 constitute a second case compartment 42 that accommodates the drive transmission mechanism 20, the auxiliary tape roll 14, the second supply spool 15, and the take-up spool 16.

Specifically, the drive transmission mechanism 20 is disposed in a space enclosed by the first frame part 32 and the second frame part 33. The auxiliary tape roll 14, the second supply spool 15, and the take-up spool 16 are disposed in a space enclosed by the second cover part 34 and the second frame part 33.

The first frame part 32 has a first side wall 32A, a partitioning wall 32B, and a first guide 32C. The first side wall 32A constitutes an outer side surface of the case 35 that extends in the up-down direction. The partitioning wall 32B extends in the front-rear direction and in the left-right direction to have a surface perpendicular to the up-down direction. The partitioning wall 32B is aligned with (overlaps) the printing tape roll 11 and the drive transmission mechanism 20 in the up-down direction.

The first guide 32C is a portion around which the printing tape 11A paid off the printing tape roll 11 is configured to be wrapped. The first guide 32C has a plurality of plate-like ribs arranged to be spaced apart from one another in a circumferential direction of the printing tape roll 11. The ribs protrude outward in radial directions of the printing tape roll 11 such that a protruding amount (i.e., height) of each rib increases toward the bottom thereof.

The second frame part 33 has a second side wall 33A, the head opening 33B, an outlet 33C, and a second guide 33D.

The second side wall 33A constitutes an outer side surface of the case 35 that extends in the up-down direction. The head opening 33B is a notch provided by cutting out a portion of the second side wall 33A. The head opening 33B is a space where the print head 102 is located in the state where the printing cassette 10 is mounted in the device body 100.

Printing is performed on the printing tape 11A in the head opening 33B by the print head 102. The head opening 33B is open downward to the bottom of the printing cassette 10 so that the print head 102 can be inserted in the head opening 33B from below.

As illustrated in FIG. 8, the printing tape 11A and the ink ribbon 14A extend in the left-right direction through the head opening 33B. In the head opening 33B, the printing tape 11A is exposed to the outside of the case 35 and is overlaid on the ink ribbon 14A. After printing is performed on the printing tape 11A, the printing tape 11A is configured to be discharged, through the outlet 33C, to the outside of the printing device 1 (device body 100).

The second guide 33D is a portion of the second frame part 33 around which the printing tape 11A paid off the printing tape roll 11 is configured to be wrapped, just like the first guide 32C. The second guide 33D has a plurality of plate-like ribs arranged to be spaced apart from one another in ae circumferential direction of the auxiliary tape roll 14. The ribs protrude outward in radial directions of the auxiliary tape roll 14. The protruding amount (i.e., height) of each rib decreases toward the bottom thereof

Conveyance and Printing of Tape with the Device Body

In the state where the printing cassette 10 is mounted in the device body 100, the print head 102 is at a position in the head opening 33B overlapping the printing tape 11A and the ink ribbon 14A in the front-rear direction.

The printing tape 11A is conveyed by the platen roller 103 into the head opening 33B where the printing tape 11A is pressed against the print head 102 by the platen roller 103 so as to be heated by the heating elements of the print head 102 through the ink ribbon 14A. As a result, some of the ink provided on the surface of the ink ribbon 14A is transferred onto the printing tape 11A, by which characters, symbols, and the like are formed (printed) on the printing tape 11A.

The platen roller 103 continues to convey the printed printing tape 11A toward the outside of the printing cassette 10 through the outlet 33C. The platen roller 103 is rotated by the platen gear 104 that is meshingly engaged with the output gear 21. The platen roller 103 is pivotable, through the movement of the platen holder 105, between a remote position separated from the printing cassette 10 (not illustrated) and a pressing position where the platen gear 104 is meshingly engaged with the output gear 21 (illustrated in FIG. 9).

In the state where the case 35 of the printing cassette 10 is inserted in the cassette accommodation portion 101, the drive shaft 106 is engaged with the input gear 22 and the platen gear 104 meshes with the output gear 21.

Specifically, when the platen roller 103 pivots toward the head opening 33B in the state where the drive shaft 106 is inserted in the take-up spool 16 and input gear 22, the platen gear 104 comes into meshing engagement with the output gear 21.

The output gear 21 is rotated when the drive shaft 106 rotates the input gear 22 in the state where the printing cassette 10 is attached to the cassette accommodation portion 101. The platen gear 104 is rotated by the rotation of the output gear 21, and the platen roller 103 is then rotated in accordance with the rotation of the platen gear 104.

FIG. 10A is a diagram schematically illustrating a state where the platen gear 104 is engaged with the output gear 21 as viewed in a direction parallel to the rotational axis L2 of the platen gear 104. In this state, a connection angle ϕ formed by a first straight line S1 and a second straight line S2 is greater than a pressure angle θ of the platen gear 104. Here, the first straight line S1 connects the rotational axis L2 of the platen gear 104 to a contact point N where the printing tape 11A contacts the platen roller 103, and the second straight line S2 connects the rotational axis L2 of the platen gear 104 to the rotational axis L4 of the output gear 21.

The first straight line S1 is parallel to a direction in which the printing tape 11A is nipped between the platen roller 103 and the print head 102. As illustrated in FIG. 10B, the pressure angle θ is an angle formed by a radial line S3 and a tangent line S4 of a tooth face at a pitch point on the tooth surface (i.e., an intersection of the tooth surface with a pitch circle C of the platen gear 104).

Since the connection angle ϕ is greater than the pressure angle θ, a reaction force F0 generated at a mesh point E between the platen gear 104 and the output gear 21 includes a component in a direction in which the platen roller 103 is pushed against the printing tape 11A.

### 2. Technical Advantageous of the Embodiment

The embodiment described above can achieve the following technical advantages.

(1a) Since the platen gear 104 is urged toward the rotational axis L4 of the output gear 21, variation in the reaction force on the platen gear 104 caused by changes in conveyance torque can be suppressed. As a result, the nip load of the platen roller 103 can be stabilized while providing an alignment mechanism for the platen roller 103.

(1b) Setting the connection angle ϕ between the platen gear 104 and the output gear 21 greater than the pressure angle θ of the platen gear 104 can improve stability in the nip load of the platen roller 103.

(1c) The gear urging spring 120 can urge the platen gear 104 toward the rotational axis L4 of the output gear 21 through a simple configuration.

(1d) The first pressure receiving part 111C and the second pressure receiving part 111D of the pressing member 111 are arranged between the first operating part 111A and the second operating part 111B in the axial direction of the roller sleeve 103B. With this structure, changes in the nip load applied on the roller sleeve 103B attributed to unbalance between the load of the first roller urging spring 112 and the load of the second roller urging spring 113 can be suppressed.

(le) With respect to the axial direction of the roller sleeve 103B, the distance D1 from the center P of the roller sleeve 103B to the first operating part 111A is equal to the distance D2 from the center P of the roller sleeve 103B to the second operating part 111B, and the distance D3 from the center P of the roller sleeve 103B to the first pressure receiving part 111C is equal to the distance D4 from the center P of the roller sleeve 103B to the second pressure receiving part 111D. This configuration can further suppress changes in the nip load applied on the roller sleeve 103B.

(1f) In the variation of FIG. 5 where only one pressure receiving part 111F is provided at the pressing member 111′, changes in the nip load applied on the roller sleeve 103B can be suppressed by setting the distance D1′ from the pressure receiving part 111F to the first operating part 111A equal to the distance D2′ from the pressure receiving part 111F to the second operating part 111B in the axial direction of the roller sleeve 103B.

(1g) The pressing member 111 is mounted on the platen holder 105 such that the pressing member 111 is pivotably movable relative to the platen holder 105. This structure can suppress changes in the nip load on the roller sleeve 103B resulting from unbalance between the load of the first roller urging spring 112 and the load of the second roller urging spring 113.

[Variations and Modifications]

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(2a) The printing device of the disclosure need not be a device configured to use an ink ribbon for printing, like the printing device 1 of the embodiment. For example, the printing device of the disclosure may be a device configured to perform printing on a strip-like thermal paper. In this case, a paper cassette need not include an ink ribbon.

Alternatively, the printing device of the disclosure may use a stencil tape as a printing tape therefor, so that a printing pattern can be perforated in the stencil tape with a thermal head. When using a stencil tape as the printing tape, a laminating tape may be used in place of the ink ribbon as an auxiliary tape for protecting the stencil tape.

(2b) In the printing device 1 of the embodiment described above, the device body 100 includes the gear urging spring 120. However, a gear urging spring (like the gear urging spring 120) may not be provided. Rather, the device body of the printing device of the disclosure may include a member (other than a gear urging spring) for urging a platen gear toward a transmission gear (output gear 21 of the embodiment).

(2c) In the printing device of the disclosure, the pressing member may have one operating part or three or more operating parts. Also, the pressing member may have three or more pressure receiving parts. Still further, the pressing member need not be pivotable relative to the platen holder.

(2d) In the printing cassette 10 of the embodiment, the drive transmission mechanism 20 may be disposed above the printing tape roll 11, or below the conveying path for the printing tape 11A. Further, the printing cassette 10 may not include the drive transmission mechanism 20. In other words, the platen gear 104 may be configured to mesh with a transmission gear provided in the device body 100, not in the printing cassette 10.

(2e) Functions possessed by a single component in the embodiment described above may be distributed among a plurality of components, and functions possessed by a plurality of components in the described embodiment may be integrated into a single component. Further, some of the parts and components of the described embodiment may be omitted. Still further, at least some of the parts and components in the embodiment may be added to or replaced with those of the above-described variations and modifications. The present disclosure encompasses every aspect included in the technical concepts that can be identified and read from the attached claims.

[Remarks]

The printing device 1 is an example of a printing device. The printing cassette 10 is an example of a printing cassette. The cassette accommodation portion 101 is an example of a cassette accommodation portion. The print head 102 is an example of a print head. The platen roller 103 is an example of a platen roller. The platen holder 105 is an example of a platen holder. The platen gear 104 is an example of a platen gear. The roller urging portion 110 is an example of a roller urging portion. The platen shaft 103A is an example of a platen shaft. The roller sleeve 103B is an example of a roller sleeve. The roller body 103C is an example of a roller body. The reduced diameter portion 103E is an example of a center portion of the roller sleeve. The gear urging spring 120 is an example of a gear urging spring. The pressing member 111 is an example of a pressing member of the roller urging portion. The first roller urging spring 112, the second roller urging spring 113, and the roller urging spring 114 are examples of a roller urging spring. The first operating part 111A is an example of a first operating part. The second operating part 111B is an example of a second operating part. The first pressure receiving part 111C is an example of a first pressure receiving part, and the second pressure receiving part 111D is an example of a second pressure receiving part. The pressure receiving part 111f is an example of a single pressure receiving part. The output gear 21 is an example of a transmission gear.

What is claimed is:

1. A printing device comprising:
a cassette accommodation portion to which a printing cassette incorporating a printing tape is detachably attachable;
a print head provided in the cassette accommodation portion;
a platen roller configured to face the print head;
a platen holder holding the platen roller such that the platen roller is rotatable about a platen-roller rotational axis, the platen holder being configured to move the platen roller in a direction crossing the platen-roller rotational axis;
a platen gear configured to mesh with a transmission gear to receive a drive force from the transmission gear, the platen gear being configured to be urged toward a transmission-gear rotational axis of the transmission gear; and
a roller urging portion configured to urge the platen roller toward the print head,
wherein the platen roller comprises:
a platen shaft to which the platen gear is fixed;
a roller sleeve extending in an axial direction, the platen shaft extending through the roller sleeve in the axial direction, the roller sleeve having a center portion and two outer end portions outside the center portion in the axial direction, the center portion being connected to the platen shaft such that a torque can be transmitted from the platen shaft to the roller sleeve, each of the two outer end portions having an inner peripheral surface that is spaced away from an outer peripheral surface of the platen shaft; and
a roller body provided over an outer peripheral surface of the roller sleeve,
wherein the platen gear is positioned outside the roller sleeve in the axial direction, and
wherein the roller urging portion is configured to urge the roller sleeve toward the print head.

2. The printing device according to claim 1,
wherein the platen gear is rotatable about a platen-gear rotational axis and the platen roller is configured to contact the printing tape at a contact point, and
wherein, when the platen gear is viewed in a direction parallel to the platen-gear rotational axis in a state where the platen gear meshes with the transmission gear, an angle formed between a first line and a second line is greater than a pressure angle of the platen gear, in which:
the first line is a line connecting the platen-gear rotational axis to the contact point; and
the second line is a line connecting the platen-gear rotational axis to the transmission-gear rotational axis.

3. The printing device according to claim 1, further comprising a gear urging spring configured to urge the platen shaft toward the transmission gear.

4. The printing device according to claim 1,
wherein the roller urging portion comprises:
a pressing member in contact with the roller sleeve; and
a roller urging spring urging the pressing member to be pressed against the roller sleeve.

5. The printing device according to claim 4,
wherein the roller urging spring is positioned between the platen holder and the pressing member.

6. The printing device according to claim 4,
wherein the roller urging spring comprises a first roller urging spring and a second roller urging spring, and
wherein the pressing member comprises:
a first operating part and a second operating part in contact with the roller sleeve and spaced apart from each other in the axial direction; and
a first pressure receiving part and a second pressure receiving part spaced part from each other in the axial direction, the first pressure receiving part being in contact with the first roller urging spring and the second pressure receiving part being in contact with the second roller urging spring, the first pressure receiving part and the second pressure receiving part being positioned between the first operating part and the second operating part in the axial direction.

7. The printing device according to claim 6,
wherein the roller sleeve defines a center in the axial direction,
wherein the center of the roller sleeve and the first operating part define a first distance in the axial direction therebetween,
wherein the center of the roller sleeve and the second operating part define a second distance in the axial direction therebetween, the second distance being equal to the first distance,
wherein the center of the roller sleeve and the first pressure receiving part define a third distance in the axial direction therebetween, and
wherein the center of the roller sleeve and the second pressure receiving part define a fourth distance in the axial direction therebetween, the fourth distance being equal to the third distance.

8. The printing device according to claim 4,
wherein the pressing member comprises:
a first operating part and a second operating part in contact with the roller sleeve and spaced apart from each other in the axial direction; and
a single pressure receiving part in contact with the roller urging spring, the pressure receiving part being positioned between the first operating part and the second operating part in the axial direction, and
wherein, with respect to the axial direction, the pressure receiving part and the first operating part define a distance therebetween that is equal to a distance between the pressure receiving part and the second operating part.

9. The printing device according to claim 4,
wherein the pressing member is supported by the platen holder such that the pressing member is pivotable relative to the platen holder.

10. The printing device according to claim 1,
wherein the transmission gear is provided at the printing cassette and is configured to mesh with the platen gear upon attachment of the printing cassette to the cassette accommodation portion.
